(19) United States
(12) Patent Application Publication
(10) Pub. No.: US 2005/0106743 A1
(43) Pub. Date: May 19, 2005

(54) Single jet, single stage cryogenic modulator

(75) Inventors: Giacinto Zilioli, Cernusco Sul Naviglio (IT); Jan Beens, Ta Castricum (NL)

Correspondence Address: NIXON & VANDERHYE, PC, 1100 N GLEBE ROAD, 8TH FLOOR, ARLINGTON, VA, 22201-4714, US

(73) Assignee: THERMO ELECTRON S.p.A, Rodano (MI) (IT)

(21) Appl. No.: 10/507,763

(22) PCT Filed: Jul. 18, 2002
(86) PCT No.: PCT/IB02/02787

(30) Foreign Application Priority Data
Mar. 15, 2002 (IT) MI2002 A 000549

(51) Int. Cl. G01N 30/02

(52) U.S. Cl. 436/161

(57) ABSTRACT

This invention relates to a modulator for use in gas chromatographic analyses, in particular for comprehensive two-dimensional gas chromatography, adapted to alternatively trap and release fractions of solutes in a length of a capillary column within a chromatographic oven, of the type comprising one nozzle placed to spray one jet in one corresponding capillary column section along said capillary column length, said nozzle being connected to a source of liquid CO₂ and means for alternatively causing a jet of gaseous CO₂ to impinge during a predetermined time on said capillary column section and to leave the oven atmosphere to heal said capillary column section after said predetermined time. By controlling said capillary column section cooling time by the single jet and said column section heating time by the oven atmosphere in each modulation cycle comprising a heating time and a cooling time a perfect modulation of the sample fractions can be ontained.

This invention relates to an improvement made to what is covered by the International Patent Application PCT/IB01/02253 filed on Nov. 28, 2001, the specification of which is to be considered as wholly comprised herein.

### FIELD OF THE INVENTION

### BACKGROUND OF THE INVENTION

In its more general formulation, the invention covered by the above stated International Application relates to a cryogenic modulator adapted for use in gas chromatography analyses, in particular for comprehensive two-dimensional gas chromatography (comprehensive 2D GC), and operates in order to alternatively trap and release fractions of solutes in a length of a capillary column within a gas chromatographic oven. This modulator comprises at least one nozzle so arranged to spray at least one jet of a cryogenic substance on at least a corresponding section along said capillary column length, the nozzle being connected to a source of liquid CO₂ through a related valve. Means are provided for alternatively opening said valve for a predetermined time in order to have a jet of CO₂ impinging for said predetermined time on said column section, leaving the oven atmosphere to re-heat said column section after said predetermined time.

In the shown embodiments of said International Application the use of two jets is foreseen for 2DGC, said two jets being spaced on said capillary column length. The jets are alternatively opened and closed according to a well defined modulation cycle time depending on the sample and analysis. When the upstream jet is closed the related capillary column section is heated by the oven atmosphere in order to allow a well defined peak portion to enter the column length between said two jets. The peak portion is then re-focused by the second jet which is in function and then sent to the second column by closure of said second jet and heating of the related column section. The cooling time of each jet is here about 50% of the modulation time.

### SUMMARY OF THE INVENTION

It has been now surprisingly ascertained that it is possible to obtain a satisfactory operation of the modulator, in case of two-dimensional gas chromatography, by using a modulator with a single jet in a single stage mode, on the condition of suitably controlling the short heating times of the capillary column section where the jet impinges, in each modulation period.

Accordingly, the present invention relates to a cryogenic modulator of the type referred to, wherein means are provided for controlling the capillary column section heating time by the oven atmosphere in each modulation cycle comprising a heating time and a cooling time. Accordingly, means are provided for controlling in time the opening and closing periods of a valve placed on the CO₂ feeding duct to the single jet, or of a shutter placed to momentarily deviate the cooling jet from the column section.

### BRIEF DESCRIPTION OF THE DRAWINGS

The invention will be now described with reference to the enclosed drawings, in which:

FIG. 1 is a scheme of a modulator according to the present invention.

FIG. 2 is a detail of the jet configuration and column support of the modulator of FIG. 1.

FIGS. 3, 4 and 5 are diagrammatic representations respectively in front view, side view and bottom view of a preferred embodiment of the jet configuration.

FIG. 6 is a chromatogram showing modulated (according to the invention) and unmodulated peaks of benzothiophene and n-dodecane.

FIG. 7 shows a single modulated peak of benzothiophene.

FIG. 8 shows a single modulated peak of n-dodecane.

FIG. 9 shows an alternative embodiment of the invention.

FIGS. 10, 1 1,12 and 13 show particulars of the embodiment of FIG. 9.

FIG. 14 shows the embodiment of FIGS. 9 to 13 as housed in a gas chromatographic instrument.

### MODES FOR CARRYING OUT THE INVENTION

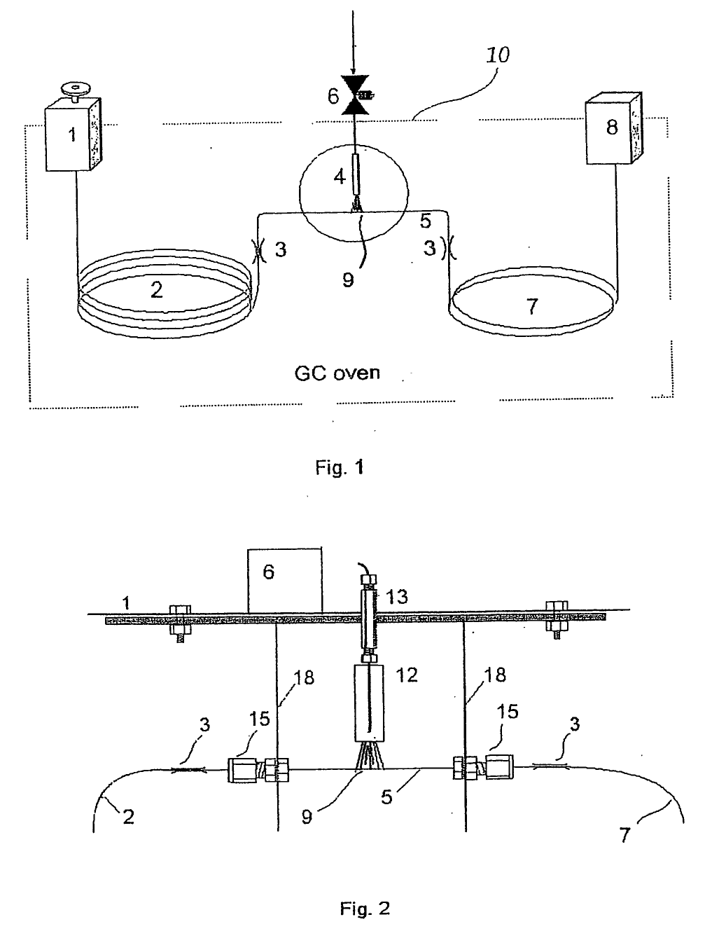

With reference to the drawings, FIG. 1 is a scheme of a comprehensive 2D GC (or GC×GC) system with a modulator according to this invention. The system comprises, in a GC oven 10, an injector 1, a first column 2 and a second column 7 which are connected at a 3 according to a well known technique by means of a column or capillary length 5. The second column 7 ends in a detector 8.Such second column 7 can be optionally housed in a dedicated box wherein a pre-set temperature difference with the oven is maintained. On said capillary length 5 a single nozzle 4 operates by spraying a cooling jet on a section 9 of said capillary length 5. To this end, the nozzle 4 is fed by a source of liquid CO₂ under the control of a suitable valve 6. For instance, the valve is an electrical-driven two-way valve (Asco, Florham Park. N.J. USA) that alternatively opens and closes the liquid CO₂ line according to suitable opening and closure timings so that the section 9 of the capillary length 5 is directly cooled to trap and focus a sample fraction, and thereafter the same fraction is remobilised by the heat of the surrounding oven air. The closing time of the valve 6 is comprised between 50 and 600 ms and preferably between 150 and 300 ms on a cycle or modulation time (one opening and one closure) which is normally in the range of 1 to 6 seconds. In particular, the closing time depends on the capillary section mass (thicker walls), as it has been ascertained in that a capillary with more mass involves a greater closing time to leave the capillary section to sufficiently heat in order re-mobilize the sample peak portion.

For instance, in case of a capillary section having a diameter of 100 μm, the jet closing time is comprised between 100 to 300 ms. In general said closing time can be experimentally determined and is much shorter than the jet opening time in each cycle or modulation time and independent from the cooling time. The heating time can be controlled by an electronic device as a function of the capillary 5 mass (and thus diameter) on the basis of experimental results. The CO₂ line coming from the valve 6 (FIG. 2) is a capillary 40 mm long, 0.8 mm ID, which passes through the oven cover 1 by means of a zero-dead volume connector 13 and is coupled to the nozzle 4. The columns 2 and 7 are connected by means of press-fit connectors 3 to the capillary length 5 and the capillary length 5 is mounted between two metal connectors 15 applied to brackets 18 mounted on the oven wall 11. The capillary or column length 5 is preferably an uncoated capillary 100 μm I.D. and is maintained under tension between the connectors 15. Preferably such connectors are two 1/16 inch Valco (VICI, Shenkon, Schwitzerland) unions 15 mounted on the bracket 18. Tight stretching is necessary in order to avoid vibration of the capillary caused by the rather high flow of cold CO₂ that is sprayed onto the capillary. The unions are mounted onto two bands of 0.9 mm thick resilient steel. Their elasticity compensates for any differences in thermal expansion of the steel bracket and the fused silica capillary during the heating cycle of the oven.

As liquid CO₂ expands at the outlet of the nozzle, the throttling process cools the exiting gas through the Joule-Thompson effect. Since the gas is sprayed directly onto the capillary at the prevailing flow, this capillary quickly cools down to about 100° C. below the oven temperature. Closing the valve will immediately stop the cooling, and the surrounding air from the GC oven will heat up the short cooled section 9 of the capillary of about 10 mm length instantaneously to oven temperature; this will remobilize the trapped fraction and launch it into the secondary column for separation. As previously said, this closing event is effectuated only during a limited short time, so that the trapped fraction is able to be fully remobilized, but the remainder of eluting analytes from the first column is prohibited to interfere.

To prevent ice formation onto the outside of the jet at oven temperatures below about 100° C., it has been inserted in a 12 mm×8 mm diameter brass socket 12 to increase its capacity. In order to force as much CO₂ from the outlet of the jet to touch the column, the outlet can be modified to form a slit, 0.04 mm wide an 3 mm long, running in parallel above the capillary.

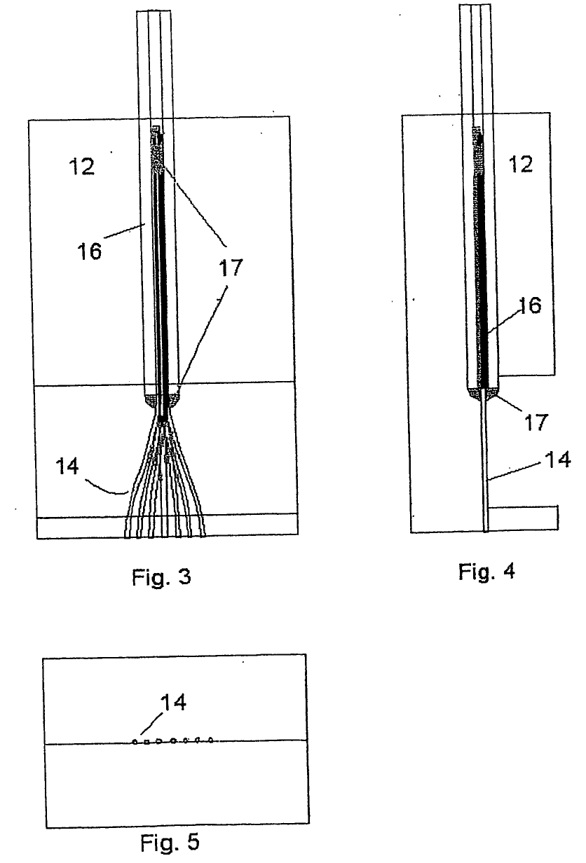

An alternative and preferred embodiment of the jet configuration is shown in FIGS. 3, 4 and 5, wherein, instead of the slit, the outlet is constructed by inserting a series of seven capillaries 14 in a row within the brass block 12. More detailed, the brass block 12 houses a connection capillary 16, for instance having 1/16 inch OD and 0.8 mm ID, said capillary 16 being connected to the CO₂ source 6. Within the end of capillary 16 are inserted seven pertrusion capillaries 14 placed according to what is shown in the figures and fixed preferably by silver soldering at 17, which is able to withstand temperatures of up to 400° C. In the shown example the free portions of the pertrusion capillaries are aligned so to run in parallel with the column length 5 so that an optimum heat exchange is enabled by generating a curtain of expanding CO₂.

The axes of the outlet openings of the capillaries 14 are placed 0.4 mm apart, so that the total length of the nozzle is 3 mm. Of course, the above stated number and dimensions can be changed at will.

The above stated construction allows to decrease the consumption of CO₂ and optimise the effectiveness of the throttling process at the nozzle outlet of the cryogenic jets.

A simple timing device that generates the 24 DC voltage for valve switching controls the modulation process.

The time controlled modulation cycles can be synchronised for instance by utilising the synchronisation system shown in the International Application No. PCT/IT02/00062.

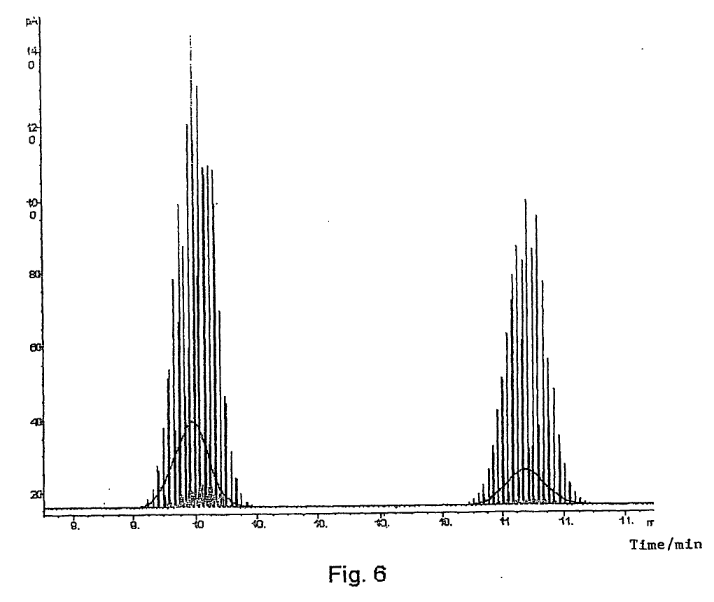

The main functions of the shown modulator are two-fold: trapping of small fractions of the effluent of the first column as narrow pulses, and re-injection of these pulses into the second column. To asses the performance of the modulator, it is sufficient to inspect the form of the peaks that are produced and calculate the bandwidth of the injection pulses. Chromatograms of a series of modulated peaks from benzothiophene and n-dodecane, respectively, are presented in FIG. 6, such chromatograms being obtained under the following conditions: 1^{st} column: 20 m×0.25 mm ID, 1 μm DB1, 2^{nd} column: 0.5 m×0.1 mm ID, 50 nm BP20, Uncoated capillary for modulation: 0.15 m×0.1 mm ID; carrier gas: helium in constant flow, temperature: 120° isothermal; modulation time: 1 sec, valve closing time for modulation: 300 ms.

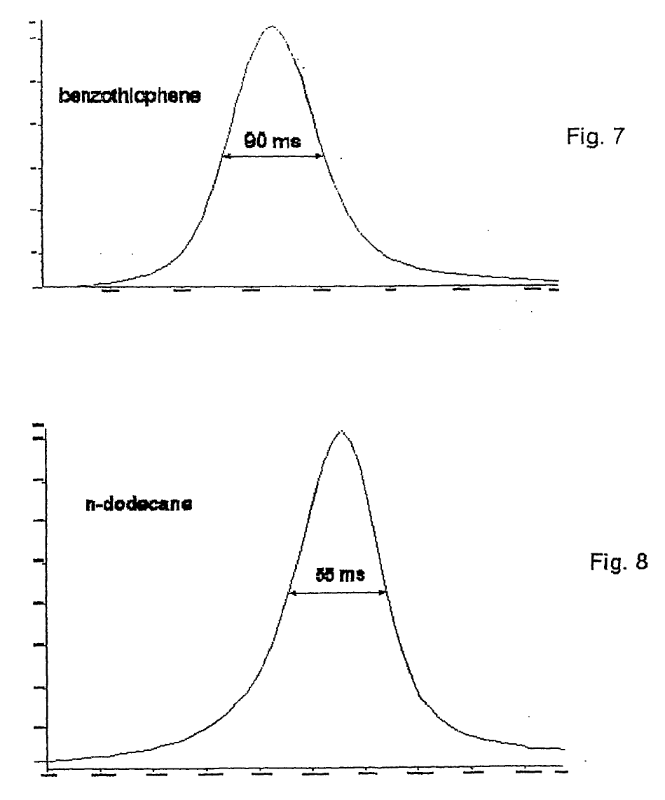

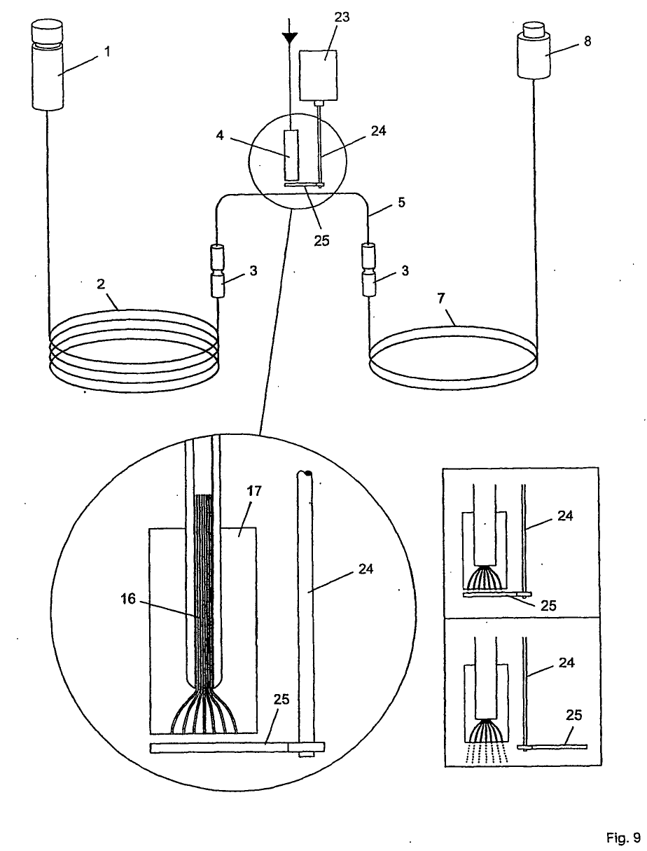

Chromatograms of single modulated peaks are depicted in FIGS. 7 and 8. From these figures it can be calculated that the band width of the focused pulses are well below 10 ms. The peak width at half height of the two peaks are 55 and 90 ms respectively.

FIGS. 9 to 12 show another embodiment of the invention, the main feature of which is that the valve controlling the CO₂ jet is dispensed with and substituted by a shutter that deviates, for given times, the CO₂ jet away from the column section.

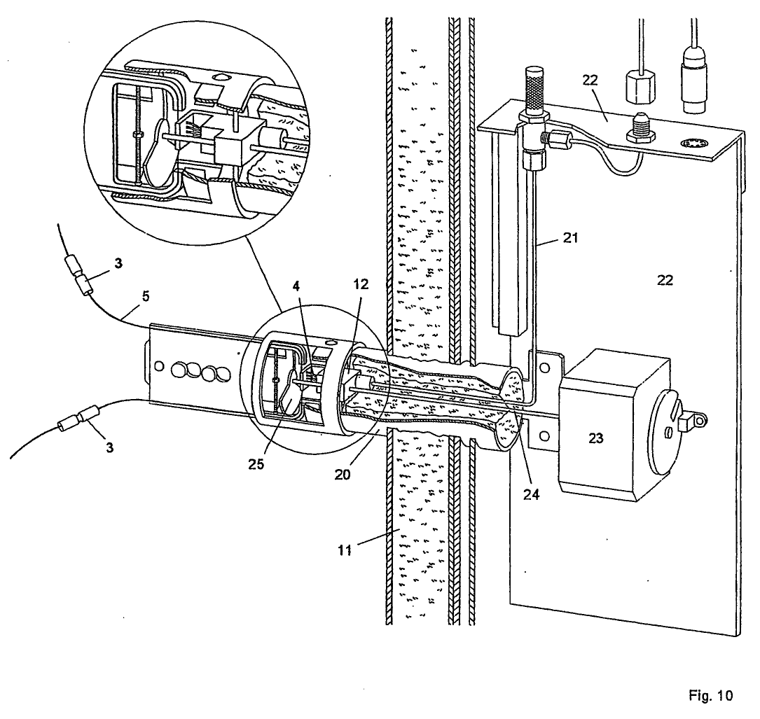

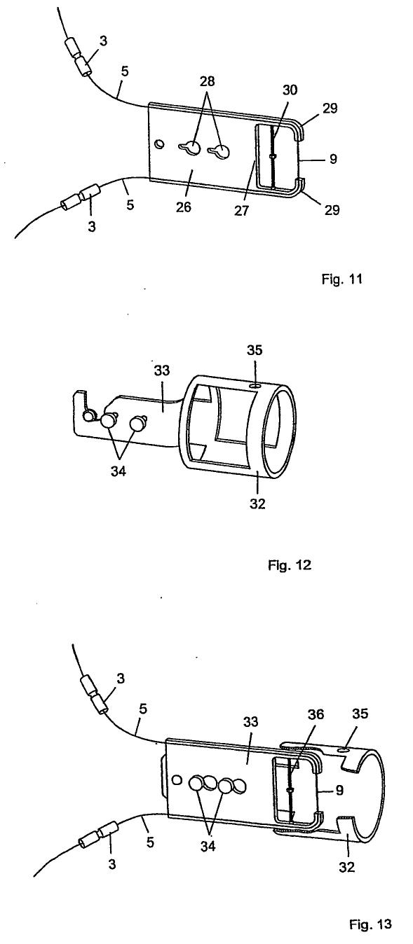

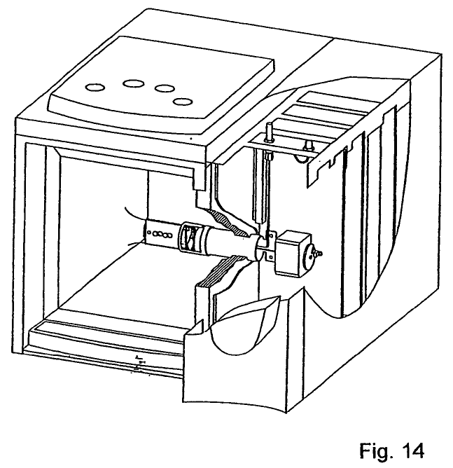

With reference to FIGS. 9 and 10, the jet 4 and brass socket 12 are fixed and mounted in a cylinder 20 crossing the oven wall 11. The jet 4 is fed by a CO₂ source (not shown) in a permanent way(during the analysis) by means of a tube 21 which can be connected at 22 to the CO₂ source. The cylinder 20, tube 21 and accessories are mounted on a plate 22 placed outside the oven. Such plate 22 carries also a stepper (a step by step motor) 23 having a shaft 24 extending parallel to the jet nosle and carrying at its free end a shutter 25 in the form of a circle sector.

This shutter is placed between the nozzle free end and the capillary length 5 and is controlled by the motor 23 in order to be rapidly moved between two positions, namely a position in which it does not interfere with the jet and a position in which the shutter 25 interferes with the CO₂ jet in order to deviate the same from the column section 9, allowing heating of the same by the oven atmosphere. The times in which the shutter 25 deviates the CO₂ jet are substantially the same to that of the valve closure in the previously shown embodiment and can be experimentally determined, being in any case shorter than and independent from the times in which the jet is not deviated, in each modulation cycle.

The capillary length 5 is mounted under tension and in its proper position according to what is shown in FIGS. 10-13. The capillary length 5 (FIG. 11) is mounted, in a U configuration, into a supporting plate 26 having a central body 27 with holes 28 in the form of a key hole and a pair of resilient arms 29 which can be forced toward a more spaced-apart position by a known screw device 30. The capillary length 5 is fixed, for instance by glueing, to the plate 26 and in particular to the arms 29 thereof and its central section 9 is placed under tension by means of the device 30.

A brief tube 32 (FIG. 12) has a protruding arm 33 carrying pins 34 to accommodate the plate 26 in a well defined position as shown in FIG. 13, in order to exactly place the column section 31 with reference to the tube 32. The tube 32, on turn, has holes 35 by means of which it can be snap-fitted on the tube 20 (FIG. 10) so to warrant a precise relative position of the column section 31 with reference to the jet 4 and shutter 25.

It is to be finally noted that the present modulator can act as an injection focusing device and/or as a peak narrowing and then a detector sensitivity enhancing device in a conventional one-dimensional GC system.

1. A modulator for use in gas chromatographic analyses, in particular for comprehensive two-dimensional gas chromatography, adapted to alternatively trap and release fractions of solutes in a length of a capillary column within a chromatographic oven, of the type comprising one nozzle placed to spray one jet in one corresponding capillary column section along said capillary column length, said nuzzle being connected to a source of liquid CO₂, and means for alternatively causing a jet of gaseous CO₂ to impinge during a predetermined time on said capillary column section and to leave the oven atmosphere to heat said capillary column section after said predetermined time, characterised in that means are provided for controlling said capillary column section cooling time by the single jet and said column section heating time by the oven atmosphere in each modulation cycle comprising a heating time and a cooling time.

2. A modulator according to claim 1, characterised in that said means for controlling said capillary column section cooling time by the single jet and said capillary column section heating time are operated to obtain a cooling time much greater than the heating time in each modulation cycle.

3. A modulator according to claim 1, wherein said capillary column length is an uncoated capillary.

4. A modulator according to claim 1, wherein said heating time is independent from the modulation cycle time.

5. A modulator according to claim 4, wherein said heating time is set depending on the mass of said capillary column section.

6. A modulator according to claim 5, wherein said heating time is from 50 to 600 ms.

7. A modulator according to claim 6, wherein said heating time is from 150 to 300 MS.

8. A modulator according to one of the preceding claim 1, wherein said nozzle has an opening in the form of a slit in parallel to said capillary length.

9. A modulator according to claim 8, wherein said slit is about 0.04 mm wide and about 3 mm long.

10. A modulator according to claim 1, wherein said nuzzle is formed by a set of capillaries aligned in parallel to said capillary column length.

11. A modulator according to claim 9, wherein the upstream end of said capillaries open in a common CO2 feeding duct, to which the capillaries are glued or soldered.

12. A modulator according to claim 11, wherein said capillaries each have an inner diameter of the order of 0.11 mm and form a curtain having a length of about 3 mm.

13. A modulator according to claim 1, wherein said nozzle is inserted in a metal socket.

14. A modulator according to claim 13, wherein said socket is in the form of a brass tube.

15. A modulator according to claim 1, wherein at least a part comprising said section of said column section length is mounted in stretched conditions.

16. A modulator according to claim 15, wherein said column length is mounted between two resilient brackets.

17. A modulator according to claim 15, wherein said column length part is mounted between two resilient arms, controllably forceable to increase the distance between their free ends carrying the column length part.

18. A modulator according to claim 1, of the type comprising a valve placed to control the connection between said source of CO₂, and means for alternatively opening said valve for a predetermined time, characterised in that means are provided for controlling in time the opening and closure of said valve.

19. A modulator according to claim 1, wherein said CO₂ jet is continuous during each analysis and a shutter deviates said CO₂ jet from the column section during the heating time of each cycle.

20. A modulator according to claim 19, wherein said shutter is mounted on a shaft and controlled to rotate in and out the space between the jet nozzle and the column section by a step-by-step motor.

21. A method for modulating solutes in gas chromatographic analyses, in particular for comprehensive two-dimensional gas chromatography, by means of a modulator of the type comprising one nuzzle placed to spray one jet on one corresponding capillary column section along said capillary column length, said nozzle being connected to a source of liquid CO₂, and means for alternatively causing a jet of gaseous CO₂ to impinge for a predetermined time on said capillary column section and to leave the oven atmosphere to heat said capillary column section after said predetermined time, characterised by a different controlled timing of the capillary column section cooling phase and of the capillary column section heating phase by the oven air, in each modulation cycle comprising a cooling phase and a heating phase.

22. A method according to claim 21, wherein said cooling phase is controlled to operate said CO2 jet by a time period greater than that of the heating phase.

23. A method according to claim 20, wherein said heating phase time is set independently from the cycle total time.

24. A method according to claim 21 characterised in that the start of each cycle is synchronised by means of a detecting system according to PCT/IT02/0062.

25. Use of a modulator according to claim 1, for modulating the injected fractions immediately downstream the injector in a gas chromatographic system.

26. Use of a modulator according to claim 1, for modulating the eluting fractions from a gas chromatographic column immediately upstream the detector of a gas chromatographic system.
